(19) United States
(12) Patent Application Publication
(10) Pub. No.: US 2026/0062254 A1
(43) Pub. Date: Mar. 5, 2026

(54) ELEVATOR SYSTEM WITH DATA-POWER NODES FOR ELEVATOR OPERATING TERMINALS

(71) Applicant: INVENTIO AG, Hergiswil (CH)

(72) Inventor: Dennys Taiana, Losone (CH)

(21) Appl. No.: 19/100,025

(22) PCT Filed: Sep. 5, 2023
(86) PCT No.: PCT/EP2023/074229

§ 371 Date: Jan. 30, 2025

(30) Foreign Application Priority Data
Sep. 6, 2022 (EP) 22194175.0

(51) Int. Cl. B66B 1/34

(52) U.S. Cl. CPC B66B 1/3453

(57) ABSTRACT

An elevator system has an electrical power cable that extends essentially inside an elevator shaft and is coupled to a power supply configured to output a voltage of a predetermined value. An elevator controller and a plurality of operating terminals are coupled to the electrical power cable. Each operating terminal is configured to receive electrical power from the power supply and to send and receive data signals via the electrical power cable in connection with an elevator call entered by a user at an operating terminal. The elevator controller is configured to send and receive data signals via the electrical power cable in connection with the elevator call.

### Description

The technology described herein relates generally to an elevator system. Exemplary embodiments of the technology relate in particular to a coupling of elevator operating terminals to an elevator control system. Exemplary embodiments of the technology further relate to a method for operating such an elevator system.

In known elevator systems, a user can input an elevator call at an elevator operating terminal, hereinafter referred to as “operating terminal”. According to one control technology used in an elevator system, a destination call control technology, an operating terminal is arranged on a floor of a building to call an elevator by entering a desired destination while standing on that floor; such a call is referred to as “destination call”. The operating terminal may have a keypad with a set number of keys assigned to the floors served by the elevator system, or a touchscreen that displays fields that represent the floors served by the elevator system. The operating terminal may have a power supply port and a data port, wherein a power cable connects the power supply port to a power source (e.g., 24/48 VDC), and wherein a data cable connects the data port directly or via a switch to the elevator control system. The data cable is usually an Ethernet cable provided with an RJ45 connector. Alternatively, the operating terminal may be powered using a power over Ethernet (POE) technology, e.g., specified in IEEE standard 802.3af. The more floors and, hence, more operating terminals a building has, the more cables are needed and the more complex the routing of the cables becomes. For example, a cable (e.g., with an RJ45 connector) must be custom-made to a predefined length, e.g., a cable must be trimmed to a length to reach a switch in the elevator shaft or an operating terminal on a specific floor. There is, therefore, a need for a technology that addresses these cable-related issues.

One aspect of the technology described herein relates to an elevator system having an elevator controller, an elevator car, a plurality of operating panels for users to enter an elevator call, a predetermined number of cable connectors and an electrical power cable extending essentially inside the elevator shaft and having wires coupled to a power supply providing at least one predetermined voltage to the elevator system. The elevator controller has a first communications port configured to send and receive data signals according to a predetermined communications standard. The elevator car is movable in an elevator shaft under control of the elevator controller between floors of a building. Each operating terminals has a second communications port configured to send and receive data signals according to the predetermined communications standard. Each cable connector has pins configured to connect to the wires of the electrical power cable at a selected section of the electrical power cable. Further, the elevator system has a modulation circuitry and a predetermined number of power and modulation circuitries. The modulation circuitry is coupled to the first communications port of the elevator controller and the pins of a first cable connector and configured to feed data signals from the first communications port into the electrical power cable and to extract data signals from the electrical power cable, wherein the extracted data signals are available at the first communications port. Each power and modulation circuitry is assigned to one of the cable connectors and to one of the operating terminals, and coupled to the second communications port of the assigned operating terminal and the pins of the assigned cable connector. Such a power and modulation circuitry is configured to feed electrical power to the assigned operating terminal, to extract data signals from the electrical power cable and to feed the data signals to the assigned operating terminal, and to feed data signals from the assigned operating terminal into the electrical power cable.

Another aspect relates to a method for operating such an elevator system. According to that method a modulation circuitry and a predetermined number of power and modulation circuitry are provided which are coupled to an electrical power cable. An elevator controller is coupled to the modulation circuitry, and each power and modulation circuitry is coupled to an operating terminal. During operation of the elevator system, an elevator call is received from a user at one of the operating terminals. First data signals are inserted into the electrical power cable using the power and modulation circuitry assigned to the operating terminal that receives the elevator call, wherein the first data signals include call information derived from the elevator call. The first data signals are extracted from the electrical power cable to obtain the call information using the modulation circuitry coupled to the elevator controller. The elevator controller processes the call information, wherein the processing includes generating a confirmation message to be transmitted to the operating terminal that receives the elevator call. Second data signals corresponding to the confirmation message are inserted into the electrical power cable using the modulation circuitry coupled to the elevator controller. The second data signals are extracted from the electrical power cable to obtain the confirmation message using the power and modulation circuitry assigned to the operating terminal that receives the elevator call. The operating terminal that receives the elevator call is operated to communicate the confirmation message to the user.

The various aspects of the technology disclosed herein provide for an improved power and communications configuration in an elevator system. This improved configuration addresses, among other issues, in particular the above-mentioned cable-related issues. As the operating terminals are powered by and communicate over the electrical power cable, the complexity of trimming cables to individual and floor-specific lengths is removed. Due to the sharing of the electrical power cable for power and communications purposes, the total length of cables is reduced.

The various aspects of the technology disclosed herein facilitate installation of the elevator system. In one embodiment, for example, the electrical power cable extends from the elevator controller arranged at the, or at one of the uppermost floors to a lowermost floor. To connect an operating terminal at a particular floor to the electrical power cable, a cable connector is connected to the electrical power cable; the connection can be made at a cable section suitable for that particular floor. A communications cable connects the cable connector and the operating terminal. Assuming, for example, that the operating terminals on all floors have about the same distance to the electrical power cable, all communications cables may have about the same length eliminating the need to provide communications cable of floor-specific lengths. Further, as the electrical power cable provides direct access to electrical power and data, adding an operating terminal, for whatever reason, is facilitated; this does not necessitate an additional switch.

In one embodiment, the electrical power cable is configured as a flat cable. In such a flat cable, its wires are embedded in a coating material and fixed separately from each other at fixed locations. This allows contacting the wires at a selected section using cable connectors that implement known contacting technologies, such as lever-operated pins or screws that penetrate the coating material upon a technician acting upon them. The person skilled in the art recognizes that the electrical power cable may have another configuration, as long as its wires can be distinguished from each other and contacted at a selected cable section.

In one embodiment, which may be applicable in connection with one or more of the preceding embodiments, the predetermined communications standard is the Ethernet protocol. This is an established communications protocol for which suitable devices and cables are commercially available.

In one embodiment, which may be applicable in connection with one or more of the preceding embodiments, an Ethernet cable interconnects the second communications port of each operating terminal and the assigned power and modulation circuitry. Such Ethernet cables are typically equipped with (male) RJ45 connectors, and devices such as operating terminals are correspondingly equipped with (female) RJ45 connectors (RJ45 sockets). Even though the electrical power cable, e.g., configured as a flat cable, is used in the elevator shaft, the coupling to the operating terminal occurs by Ethernet cables so that there is no need to change the connectors at the operating terminals.

In one embodiment, which may be applicable in connection with one or more of the preceding embodiments, the modulation circuitry and its assigned cable connector are mounted as a unit to the electrical power cable. In another embodiment, the modulation circuitry is arranged in the elevator shaft separate from its assigned cable connector which is mounted to the electrical power cable. Similarly, each power and modulation circuitry and its assigned cable connector are in one embodiment mounted as a unit to the electrical power cable. In another embodiment, each power and modulation circuitry is arranged in the elevator shaft separate from its assigned cable connector which is mounted to the electrical power cable. Such a unit may have a housing in which the cable connectors and the respective circuitry are integrated. These options allow selecting an optimized way for coupling to the electrical power cable that considers the cost of the connectors and the time needed for the coupling. For example, the improved installation efficiency may be balanced against the potentially higher cost of an integrated unit.

In the following, various aspects of the improved technology are explained in more detail by means of exemplary embodiments in connection with the figures. All figures are merely schematic illustrations of methods and systems or their components according to exemplary embodiments of the improved technology. In particular, distances and size relations are not reproduced to scale in the figures. In the figures, identical elements have identical reference signs. In the drawings:

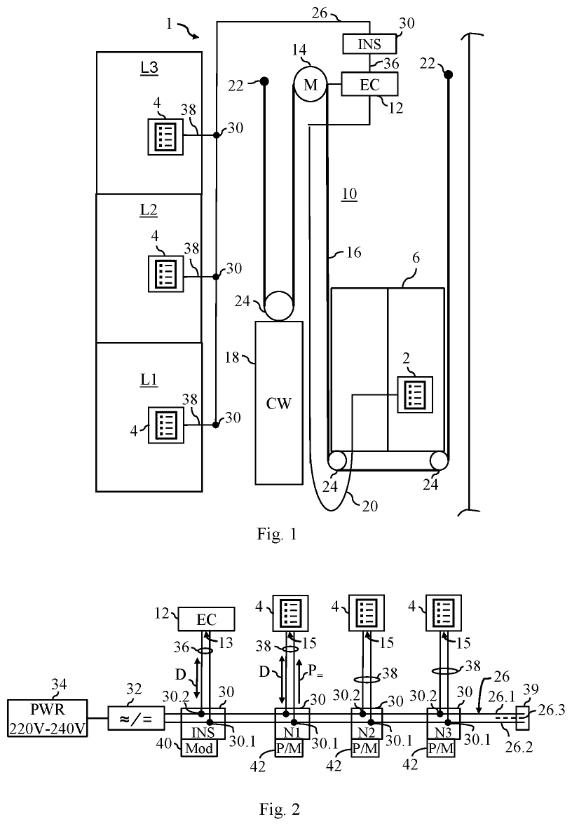

FIG. 1 shows a schematic illustration of an exemplary elevator system in a building with several floors;

FIG. 2 shows a schematic illustration of an exemplary power and communications configuration employed in the elevator system;

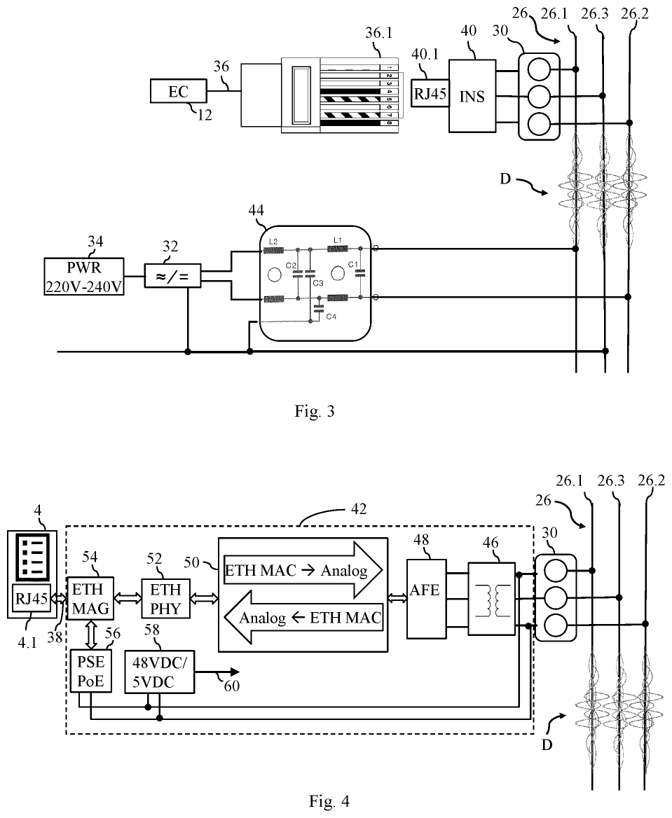

FIG. 3 shows a schematic illustration of one embodiment of a main node applied in the power and communications configuration of FIG. 2;

FIG. 4 shows a schematic illustration of a first embodiment of a terminal node applied in the power and communications configuration of FIG. 2;

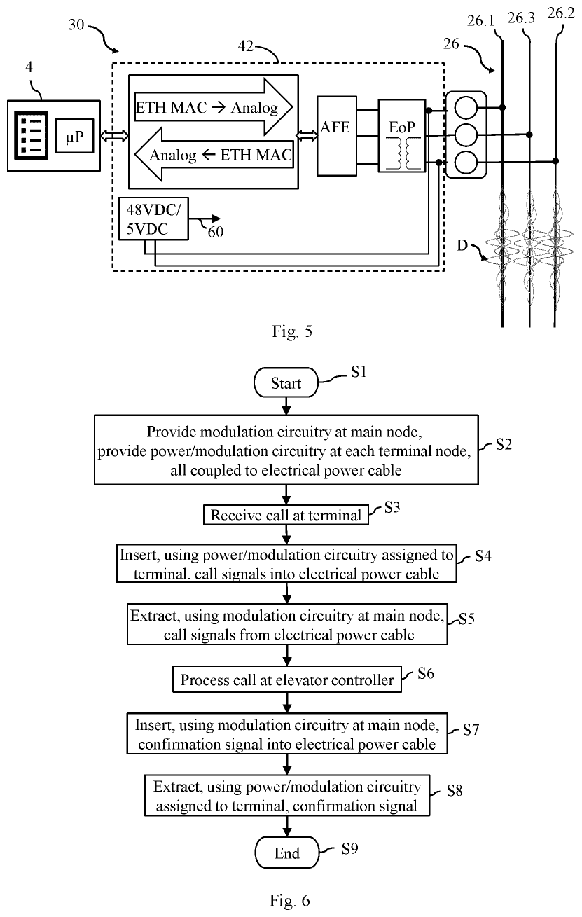

FIG. 5 shows a schematic illustration of a second embodiment of a terminal node applied in the power and communications configuration of FIG. 2; and

FIG. 6 shows a flow diagram of a method for operating an elevator system.

FIG. 1 shows a schematic illustration of an exemplary embodiment of an elevator system 1 in a building; the building can in principle be any type of multi-floor building (e.g., residential building, hotel, office building, sports station, etc.), wherein the technology described herein is particularly advantageous in very tall buildings having a plurality of floors. In the following, components and functions of the elevator system 1 are explained as far as they are believed to be helpful for an understanding of the technology described herein. The building shown in FIG. 1 has a plurality of floors L1, L2, L3 served by the elevator system 1, i.e., a user can be transported from a boarding floor to a destination floor by the elevator system 1 after inputting a call at an operating terminal 4 while standing at the boarding floor. In the illustrated exemplary embodiment, the elevator system 1 has an elevator car 6 that is movable along a travel path in the building. For example, the travel path extends along a vertical elevator shaft 10, without being limited to such a travel path. In the following, embodiments of the disclosed technology are described with reference to the exemplary elevator system 1 shown in FIG. 1.

The elevator system 1 shown in FIG. 1 further comprises an elevator controller (EC) 12, a drive machine (M) 14, a counterweight 18, a signal transmission system 20 (also referred to as hanging cable 20), a suspension means 16 (one or more steel ropes or flat belts) and a plurality of deflection pulleys 24. The suspension means 16 has two ends, each end being attached to a fixed point 22 in the elevator shaft 10. Between the fixed points 22, the suspension means 16 partially wraps around the deflection pulley 24 on the counterweight 18, a traction sheave of the drive machine 14 and the deflection pulleys 24 on the elevator car 6. The illustrated elevator system 1 is, thus, a traction elevator, wherein further details, such as guide rails for the elevator car 6 and guide rails for the counterweight 18 are not shown in FIG. 1. The elevator controller 12 is connected to the drive machine 14 and controls it to move the elevator car 6 in the shaft 10. The function of a traction elevator, the components of which and the tasks of an elevator control 12 are generally known to the person skilled in the art. The person skilled in the art recognizes that the technology described here is not limited to use in a traction elevator or the exemplary routing of the suspension means 16 shown in FIG. 1. Further, the person skilled in the art recognizes that the elevator system 1 can have a plurality of elevator cars 6 or multi-deck cars in one or more elevator shafts 10 or can have one or more groups of elevators.

In the embodiment of FIG. 1, an operating terminal 4 is arranged on each floor L1, L2, L3, and configured to communicate with the elevator controller 12 via a cable 38, cable connectors 30 and an electrical power cable 26. As used herein, a cable is an assembly of one or more wires, and which is used to carry electric current and/or data signals. Each wire may be insulated, e.g., by a plastic coating, and more than one wire may run side by side, be twisted or have any other typical configuration, with or without a common coating. The wires may be color coded. Irrespective of a particular cable configuration, its wires can be distinguished from each other and contacted at a selected cable section.

The cable 38 is configured for transmitting data signals according to a predetermined communications standard; in the embodiments described herein, the communications standard is the Ethernet protocol (IEEE-standard 802.3), and the cable 38 is hereinafter referred to as Ethernet cable 38. A further operating terminal 2 is arranged in the elevator car 6 and configured to communicate with the elevator controller 12 via the hanging cable 20. The floor-side operating terminal 4 may be referred to as landing operating terminal 4, and the car-side operating terminal 2 may be referred to as car operating terminal 2. For illustration purposes, the operating terminals 2, 4 are shown with the same symbol. The person skilled in the art recognizes that the configurations of the operating terminals 2, 4 differ. For example, if the landing operating terminal 4 allows a user to enter a destination floor, the car operating terminal 2 allows the user only, e.g., to signal an emergency and/or to affect the closing of the elevator doors. Embodiments of the technology are in the following described with reference to the destination call control technology and the operating terminals 4 arranged on the floors L1, L2, L3.

FIG. 2 shows a schematic illustration of an exemplary power and communications configuration employed in the elevator system 1. Shown are, among other components, the elevator controller 12, the operating terminals 4 and a power source 32, 34, all being coupled to the electrical power cable 26. Further details are shown in FIG. 3 to FIG. 5. The electrical power cable 26 extends inside the elevator shaft 10, as illustrated in FIG. 1, and the Ethernet cables 38 branch off the electrical power cable 26 at the cable connectors 30 to connect to the operating terminals 4 on the floors L1, L2, L3. The electrical power cable 26 has a cable coating in which wires 26.1, 26.2, 26.3 are embedded. The electrical power cable 26 can be configured as a flat cable having a predetermined width and a predetermined height, wherein the width is larger than the height. The length of the electrical power cable 26 depends, e.g., on the height of the building; it may extend from a pit (space at or near the bottom of the elevator shaft 10) to a headroom (space at or near the top of the elevator shaft 10) or machine room, for from a lowermost floor (bottom floor) to an uppermost floor (top floor) served by the elevator system 1.

The electrical power cable 26 extends in FIG. 2 between an end cap 39 and the power source 32, 34 having in the illustrated embodiment an AC/DC converter 32, which is coupled to a power outlet 34 (PWR) of the building's in-house installation (coupled to the public power grid). The power outlet 34 may output a voltage of, e.g., about 200 V-240 V (AC) that the AC/DC converter 32 converts to one or more voltage levels, e.g., of about 5 V, 24 V or 48 V (DC). One wire of the electrical power cable 26 (e.g., 26.1) may provide the voltage of about 24 V or 48 V with respect to ground (e.g., 26.2). The electrical power cable may have at least one additional wire (e.g., 26.3), e.g., for earth (0 V potential to ground/earth). The person skilled in the art recognizes that the power outlet 34 and the AC/DC converter 32 may provide other voltages, and that the AC/DC converter 32 may be omitted if AC voltage is supplied to the electrical power cable 26.

The elevator controller 12 has a communications port 13 configured to send and receive data signals according to the predetermined communications standard (Ethernet protocol) via a cable 36, which is referred to as Ethernet cable 36, coupled to a first cable connector 30. Associated with this first cable connector 30 is a modulation circuitry 40 (Mod) coupled to the Ethernet cable 36 and two pins 30.1, 30.2 of the cable connector 30. A further pin (not shown in FIG. 2) may be provided for earthing/grounding. The modulation circuitry 40 is configured to feed data signals from the first communications port 13 into the electrical power cable 26 and to extract data signals from the electrical power cable 26 making it available at the first communications port 13. The bidirectional transmission of the data signals is indicated by a double arrow D.

In one embodiment, the connector 30 is integrated in a clamping device having a cable-receiving support and a contact mechanism for manual operation by a technician. The contact mechanism is arranged to act upon the connector's pins 30.1, 30.2. In one embodiment, the contact mechanism may include one or more levers configured to force the pins 30.1, 30.2 into the cable coating until they contact the wires 26.1, 26.2, 26.3. In another embodiment, the contact mechanism may include individual screws coupled to the pins 30.1, 30.2 so that upon tightening the screws they force the pins 30.1, 30.2 into the cable coating until they contact the wires 26.1, 26.2, 26.3. During installation of the power and communications configuration illustrated in FIG. 2, the technician can position the clamping device at a desired section of the electrical power cable 26 arranged in the elevator shaft 10 and insert the electrical power cable 26 in the cable-receiving support. The technician can then operate the lever or the screws to force the connector's pins 30.1, 30.2 through the cable coating and to contact the embedded wires 26.1, 26.2, 26.3 of the electrical power cable 26. The person skilled in the art recognizes that the wires 26.1, 26.2, 26.3 may be contacted using any other method typically used for making electrical contact with wires.

Each operating terminal 4 has a communications port 15 configured to send and receive data signals according to the predetermined communications standard (Ethernet protocol) via the respective Ethernet cable 38 coupled to the cable connector 30 assigned to the respective operating terminal 4. The bidirectional transmission of the data signals to and from an operating terminal 4 is indicated by a double arrow labeled D. The operating terminals 4 can have, for example, a device identifier (also referred to as a device ID) or a password by which an operating terminal 4 is identifiable and addressable; for example, the operating terminal 4 can transmit an elevator call entered by a user along with its device ID to the elevator controller 12 which confirms the call to the operating terminal 4 identified by the device ID. In this case, information about an elevator allocated to serve the call can also be sent to the operating terminal 4 to inform the user.

Associated with each cable connector 30 is a power and modulation circuitry 42 (P/M) coupled to the cable connector's pins 30.1, 30.2 and the Ethernet cable 38 leading to the communications port 15 of the assigned operating terminal 4. The combination of a cable connector 30 and its associated power and modulation circuitry 42 may be referred to as node; FIG. 2 shows for illustrative purposes three terminal nodes N1, N2, N3. Another node may be formed by the combination of the modulation circuitry 40 and its assigned cable connector 30; this node may be referred to as main node and labeled as “INS” in FIG. 1 and FIG. 2 as an indication for being functionally and signal-wise closest to the elevator controller 12 and for one of its functions, i e., inserting data signals into the power cable 26. The person skilled in the art recognizes that another function of the main node is to extract data signals from the power cable 26.

Each power and modulation circuitry 42 of a terminal node N1, N2, N3 is configured to provide electrical power (DC voltage) to the assigned operating terminal 4. The provision of the DC voltage is indicated in in FIG. 2 by means of an arrow P=at the terminal node N1. The power and modulation circuitry 42 is configured to extract data signals from the electrical power cable 26 and to feed the (extracted) data signals to the assigned operating terminal 4. Further, the power and modulation circuitry 42 is configured to feed data signals from the assigned operating terminal 4 into the electrical power cable 26, as indicated by the double arrow D at the terminal node N1. It is contemplated that the remaining terminal nodes N2, N3 may be labeled with arrows P=and D, as well.

In one embodiment, the modulation circuitry 40 and its assigned cable connector 30 are mounted as a unit to the electrical power cable 26. This is illustrated in FIG. 2. In another embodiment, the modulation circuitry 40 is arranged in the elevator shaft 10 separate from its assigned cable connector 30 which is mounted to the electrical power cable 26. Similarly, each power and modulation circuitry 42 and its assigned cable connector 30 are in one embodiment mounted as a unit to the electrical power cable 26. This is illustrated in FIG. 2. In another embodiment, each power and modulation circuitry 42 is arranged in the elevator shaft 10 separate from its assigned cable connector 30 which is mounted to the electrical power cable 26.

FIG. 3 shows a schematic illustration of one embodiment of the main node (INS) applied in the power and communications configuration of FIG. 2. For context, FIG. 3 shows the elevator controller 12 coupled to the modulation circuitry 40 (INS), and the power source 32, 34 coupled to the electrical power cable 26 via a frequency filter circuitry 44. For coupling to the elevator controller 12, the modulation circuitry 40 has, e.g., an (female) RJ45 connector 40.1 that couples to a complementary (male) RJ45 connector 36.1 of the Ethernet cable 36. FIG. 3 shows the male RJ45 connector 36.1 as having eight wires, for example. The modulation circuitry 40 is coupled to the connector 30 which is coupled to the wires 26.1, 26.2, 26.3 of the electrical power cable 26. It is contemplated that the connector 30 may be implemented in or considered to be a part of the modulation circuitry 40.

The modulation circuitry 40 is configured to receive data signals from the elevator controller 12 and to adapt the data signals for transmission over the electrical power cable 26. Adapting the data signals includes modulating the (Ethernet) data signals onto the electrical power cable 26 using a carrier-frequency modulation system. The so-modulated data signals are transmitted at a frequency of about 30-100 MHz with a data rate of about 2 GB/s on the electrical power cable 26. Further, the modulation circuitry 40 is configured to extract data signals transmitted from an operating terminal 4 from the electrical power cable 26 and to demodulate the data signals for further processing. Exemplary modulated data signals (D) propagating on the wires 26.1, 26.2, 26.3 are shown in FIGS. 3-5. Further details regarding the operation of the modulation circuitry 40 are described in connection with the power and modulation circuitry 42 shown in FIGS. 3-5.

The data signals are typically intended (i.e., addressed) for a particular operating terminal 4, for example, for the operating terminal 4 that transmitted a user's elevator call and, in response, receives a confirmation message from the elevator controller 12. The confirmation message may acknowledge registration of the elevator call and/or specify a certain elevator assigned to serve the elevator call. Such a communication between the elevator controller 12 and the particular operating terminal 4 is bidirectional and only between the elevator controller 12 and the particular operating terminal 4. For that bidirectional communication, a unique device ID is assigned to each one of these devices so that each one can be individually addressed. In addition, the elevator controller 12 may broadcast the data signals to essentially all operating terminals 4, for example, in preparation of a service interruption (e.g., during maintenance of the elevator system 1) the operating terminals 4 may be instructed to display a message, such as “out of order” or similar.

Further, to ensure the communications and to prevent other operating terminals 4 coupled to the electrical power cable 26 from being able to process the data signals of that communication, the modulation circuitry 40 can be configured to encrypt the data signals prior to inserting them into the electrical power cable 26. Correspondingly, the modulation circuitry 40 is configured to demodulate and decrypt the data signals extracted from the electrical power cable 26 and transmitted by an operating terminal 4. For such encrypted communications, for example, passwords or identifiers assigned to the power and modulation circuitries 42 of the terminal nodes (N1, N2, N3) and the modulation circuitry 40 of the main node may be used.

The frequency filter circuitry 44 shown in FIG. 3 is configured as a wave trap, also known as a line trap. Such a wave trap includes a parallel resonant circuit coupled to the power lines (26.1, 26.2) to prevent the transmission of high frequency (40 kHz to 1000 kHz) carrier signals of power line communication to unwanted destinations. An inductive reactance of the wave trap presents a high reactance to high-frequency signals but a low reactance to mains frequency. The frequency filter circuitry 44, therefore, blocks the exemplary (HF) data signals (D) propagating on the wires 26.1, 26.2, 26.3, as shown in FIGS. 3-5.

FIG. 4 shows a schematic illustration of a first embodiment of a terminal node (N1, N2, N3) applied in the power and communications configuration of FIG. 2. For context, FIG. 4 shows the node's power and modulation circuitry 42 coupled to an RJ45 connector 4.1 of the elevator terminal 4 (via the cable 38) and the electrical power cable 26 via the connector 30, which is as described in connection with FIG. 3. The power and modulation circuitry 42 is configured to extract and demodulate/decrypt data signals intended for its operating terminal 4 from the electrical power cable 26, and to insert and modulate/encrypt data signals for transmitting them over the electrical power cable 26 to the elevator controller 12. As mentioned above, the modulation circuitry 40 at the main node is likewise configured to insert and to extract data signals from the electrical power cable 26; the following description of the power and modulation circuitry 42, therefore, applies equally to the modulation circuitry 40, except that electrical power may be provided from a separate power supply. In the illustrated power and communications configuration, the circuitries'(40, 42) respective passwords, identifiers and/or device identifiers (for addressing purposes) may be used.

In the illustrated embodiment, the power and modulation circuitry 42 includes a data coupling transformer circuitry 46, an analog front-end circuitry 48 (AFE), a digital communications processor 50 (ETH MAC), Ethernet physical layer equipment 52 (ETH PHY), Ethernet magnetics 54 (ETH MAG), power supply equipment 56 (PSE PoE) and a node power supply 58. The power supply equipment 56 (PSE PoE) and the node power supply 58 are connected to the wires 26.1 (e.g., 24/48 V) and 26.2 (e.g., ground) via the connector 30, wherein the power supply equipment 56 is connected to the Ethernet magnetics 54. The data coupling transformer circuitry 46 is connected to the wires 26.1 (e.g., 24/48 V), 26.2 (e.g., ground) and 26.3 (e.g., earth) via the connector 30. The functions of these components are summarized hereinafter.

The data coupling transformer circuitry 46 provides for galvanic isolation between the power and modulation circuitry 42 and the electrical power cable 26.

The analog front-end circuitry 48 (AFE) includes an integrated circuit for conditioning analog signals, such as amplifying, filtering and processing such signals. The analog front-end circuitry 48 may include an analog-to-digital converter (ADC) and/or a digital-to-analog converter (DAC). The analog front-end circuitry 48 is further configured to modulate data signals for transmission over the electrical power cable 26 and to demodulate data signals received from the electrical power cable 26. In addition, the analog front-end circuitry 48 is further configured to encrypt and decrypt the data signals. The digital communications processor 50 includes an Ethernet media access controller (MAC). The Ethernet MAC is defined by the IEEE standard 802.3 Ethernet standard, and implements a data-link layer, e. g, for operation at 10 Mbits/s, 100 Mbits/s or 1 Gbit/s.

Further, the MAC controller implements a media independent interface (MII) which is also defined in the IEEE standard 802.3. The MII includes a data interface and a management interface between the Ethernet MAC and the Ethernet physical layer equipment 52. The data interface has a channel for a transmitter and a separate channel for a receiver. With the management interface, upper layers can monitor and control the Ethernet physical layer equipment 52.

The Ethernet physical layer equipment 52 is the physical interface transceiver that implements the physical layer according to the IEEE standard 802.3 standard.

The Ethernet magnetics 54 (ETH MAG) provide, e.g., for electrical isolation, signal balancing, common-mode rejection, impedance matching, and EMC improvement. The following sections briefly describe each of these areas. For human safety, the IEEE specification requires a 10/100/1000BASE-T port to be able to withstand 1,500 VAC at 50 Hz to 60 Hz for 1 minute between ports or from each port to the chassis ground. Transformers can be used to provide a balanced connection to each pair of a cable and can also provide an effective rejection of common-mode signals. The common-mode rejection of a transformer functions in both signal directions of a port.

The node power supply 58 obtains electrical power (DC voltages of about, e.g., 5 V and 48 V) from the electrical power cable 26. The node power supply 58 is connected to electrical components of the power and modulation circuitry 42 to provide the obtained electrical power to these electrical components, as indicated by an arrow 60.

The power supply equipment 56 is connected to the node power supply 58 and the Ethernet magnetics 54 and configured to implement a functionality known as power over Ethernet (PoE). With this functionality, electrical power (DC voltage of, e.g., 48 V) is provided to the operating terminal 4 via the RF45 connector 4.1 and the Ethernet cable 38.

FIG. 5 shows a schematic illustration of a second embodiment of a terminal node (N1, N2, N3) applied in the power and communications configuration of FIG. 2. The second embodiment is analogous to the embodiment of FIG. 4 with the exception that the PoE functionality is directly implemented at the MAC layer. In that implementation, the Ethernet physical layer equipment 52, RJ45 connectors 4.1, Ethernet cables 38 and the Ethernet magnetics 54 shown in FIG. 4 can be omitted, which results in reduced costs.

With the understanding of the above-described elevator system 1 and its components, a description of an exemplary method for operating of the elevator system 1 is provided below with reference to FIG. 6. The exemplary description is provided with reference to an operating terminal 4 arranged on one of the floors L1, L2, L3. The elevator system 1 is in operation (i.e., not in standby mode). The method described with reference to FIG. 6 starts in a step S1 and ends in a step S9. The person skilled in the art recognizes that the division into the steps shown is exemplary, and that one or more of these steps can be divided into one or more sub-steps, or that several of the steps can be combined into one step.

Referring to a step S2, a modulation circuitry 40 is provided at the main node (INS) and at each terminal node N1, N2, N3, a power and modulation circuitry 42 is provided. The modulation circuitry 40 and the power and modulation circuitry 42 are coupled to the electrical power cable 26. In addition, the elevator controller 12 is coupled to the modulation circuitry 40, and each power and modulation circuitry 42 is coupled to an operating terminal 4, as shown, e.g., in FIG. 2 and described above.

In a step S3, an elevator call is received at one of the operating terminals 4. The operating terminal 4 allows a user to enter a desired destination floor, such an entry of a destination floor constitutes an elevator call or a destination call. Information derived from the entry of the elevator call indicates the destination floor and the operating terminal 4 that received the elevator call. Features and functions of such an operating terminal 4 are known to the person skilled in the art.

In a step S4, data signals including information derived from the elevator call are inserted into the electrical power cable 26 using the power and modulation circuitry 42 assigned to the operating terminal 4 that receives the elevator call. The power and modulation circuitry 42 modulates and encrypts the call signals, addresses them to the elevator controller 12 and inserts them as analog data signals into the electrical power cable 26, as indicated and described in connection with FIG. 4 and FIG. 5 (signals D). The encrypted call signals indicate the destination floor, the transmitting operating terminal 4 and the device ID of the elevator controller 12, or its assigned modulation circuitry 40, as the intended recipient of the call signals (data signals).

In a step S5, the data signals are extracted from the electrical power cable 26 using the modulation circuitry 40 at the main node. As the data signals are intended for the elevator controller 12, its assigned modulation circuitry 40 can demodulate and decrypt the received data signals to obtain analog call signals. The analog call signals are converted to digital call signals according to the Ethernet protocol and fed to the elevator controller 12 via the Ethernet cable 36.

In a step S6, the elevator call is processed at the elevator controller 12. The processing includes registering the elevator call, scheduling an elevator car 6 to serve the elevator call and generating a confirmation message. The scheduling includes planning a trip for the elevator car 6 from a current position to the boarding floor (if not already at the boarding floor) and from the boarding floor to the destination floor. If the elevator system 1 includes more than one elevator car 6, each having its own allocation computer, an allocation algorithm is used to allocate an elevator car 6 that is most suitable to serve the elevator call. The allocation algorithm may be implemented in the elevator controller 12, a dedicated allocation computer or in a combination of dedicated allocation computers and functions of the operating terminals 4. Such a combination may involve communications between the call-receiving operating terminals 4 and the allocation computers which take place over the electrical power cable 26. For example, the call-receiving operating terminal 4 may address the call-representing data signals to all allocation computers to request input regarding at what cost each elevator can serve the elevator call. The lowest-cost elevator can then be selected, e.g., by the call-receiving operating terminal 4.

The confirmation message (e.g., issued by the selected elevator) is to be transmitted to the operating terminal 4 from which the elevator call originates. For that purpose, the confirmation message may include the password or device ID assigned to the operating terminal 4. Further, the confirmation message may indicate the elevator car 6 that serves the elevator call.

In a step S7, the confirmation message is inserted into the electrical power cable 26 using the modulation circuitry 40 at the main node. The modulation circuitry 40 inserts the confirmation message as data signals intended for the (call-receiving) operating terminal 4 in a manner that is analogous to that described above regarding the step S4.

In a step S8 , the data signals corresponding to the confirmation message are extracted from the electrical power cable 26 using the power and modulation circuitry 42 assigned to the operating terminal 4 that transmitted the call signals (elevator call). The power and modulation circuitry 42 can demodulate and decrypt the received data signals which are subsequently converted to digital (confirmation) signals according to the Ethernet protocol and fed to the operating terminal 4 via the Ethernet cable 38, as indicated in FIG. 4. Such feeding via der Ethernet cable 38 is not required in an embodiment according to FIG. 5. Upon receipt of the confirmation message, the operating terminal 4 communicates the confirmation and/or the allocated elevator car 6 to the user. The method ends in the step S9.

1. Elevator system, comprising:
an elevator controller having a first communications port configured to send and receive data signals according to a predetermined communications standard;
an elevator car movable in an elevator shaft under control of the elevator controller between floors of a building;
an electrical power cable extending inside the elevator shaft and having wires coupled to a power supply providing at least one predetermined voltage to the elevator system;
a plurality of operating terminals, each having a second communications port configured to send and receive data signals according to the predetermined communications standard;
a predetermined number of cable connectors, each having pins configured to connect to the wires of the electrical power cable at a selected section of the electrical power cable
a modulation circuitry coupled to the first communications port of the elevator controller and the pins of a first cable connector and configured to feed data signals from the first communications port into the electrical power cable and to extract data signals from the electrical power cable, wherein the extracted data signals are available at the first communications port;
a predetermined number of power and modulation circuitries, each assigned to one of the cable connectors and to one of the operating terminals, and coupled to the second communications port of the assigned operating terminal, and the pins of the assigned cable connector, wherein such a power and modulation circuitry is configured to:
feed electrical power to the assigned operating terminal,
extract data signals from the electrical power cable and to feed the data signals to the assigned operating terminal, and
feed data signals from the assigned operating terminal into the electrical power cable.

2. Elevator system according to claim 1, wherein the electrical power cable is configured as a flat cable.

3. Elevator system according to claim 1, wherein the modulation circuitry and the first cable connector are mounted as a unit to the electrical power cable.

4. Elevator system according to claim 1, wherein the modulation circuitry is arranged in the elevator shaft separate from the first cable connector which is mounted to the electrical power cable.

5. Elevator system according to claim 3, wherein each power and modulation circuitry and its assigned cable connector are mounted as a unit to the electrical power cable.

6. Elevator system according to claim 3, wherein each power and modulation circuitry is arranged in the elevator shaft separate from its assigned cable connector which is mounted to the electrical power cable.

7. Elevator system according to claim 1, wherein the predetermined communications standard is the Ethernet protocol.

8. Elevator system according to claim 7, wherein an Ethernet cable interconnects the second communications port of each operating terminal and the assigned power and modulation circuitry.

9. Elevator system according to claim 1, wherein the electrical power cable has a cable coating in which the wires are embedded, and wherein each cable connector is configured for its pins to penetrate the cable coating and to contact the wires.

10. Elevator system according to claim 1, wherein the modulation circuitry and the power and modulation circuitries are configured to modulate and to encrypt the data signals to be fed into the electrical power cable and to demodulate and to decrypt the extracted data signals.

11. Method for operating an elevator system according to claim 1, comprising:
providing a modulation circuitry and a predetermined number of power and modulation circuitry which are coupled to an electrical power cable, wherein an elevator controller is coupled to the modulation circuitry, and each power and modulation circuitry is coupled to an operating terminal;
receiving an elevator call from a user at one of the operating terminals;
inserting, using the power and modulation circuitry assigned to the operating terminal that receives the elevator call, first data signals into the electrical power cable, wherein the first data signals include call information derived from the elevator call;
extracting, using the modulation circuitry coupled to the elevator controller, the first data signals from the electrical power cable to obtain the call information;
processing the call information by the elevator controller, wherein the processing includes generating a confirmation message to be transmitted to the operating terminal that receives the elevator call;
inserting, using the modulation circuitry coupled to the elevator controller, second data signals corresponding to the confirmation message into the electrical power cable;
extracting, using the power and modulation circuitry assigned to the operating terminal that receives the elevator call, the second data signals from the electrical power cable to obtain the confirmation message; and
operating the operating terminal that receives the elevator call to communicate the confirmation message to the user.

12. Elevator system according to claim 4, wherein each power and modulation circuitry and its assigned cable connector are mounted as a unit to the electrical power cable.

13. Elevator system according to claim 4, wherein each power and modulation circuitry is arranged in the elevator shaft separate from its assigned cable connector which is mounted to the electrical power cable.
